(19) United States
(12) Patent Application Publication
(10) Pub. No.: US 2011/0192467 A1
(43) Pub. Date: Aug. 11, 2011

(54) METHOD AND APPARATUS FOR SMOOTHING FLOW IN FLOW PASSAGES

(75) Inventors: Eliyahu Dvash, Ramat Hasharon (IL); David Gutman, Kfar Bin-Nun (IL); Yehezkel Hagbi, D.N. Hof Ashkelon (IL)

(73) Assignee: OOVAL VALVES LTD., Kiryat Malachi (IL)

(21) Appl. No.: 13/125,713

(22) PCT Filed: Oct. 29, 2009
(86) PCT No.: PCT/IL09/01011

§ 371 Date: Apr. 22, 2011

(30) Foreign Application Priority Data
Nov. 2, 2008 (IL) 195049

(51) Int. Cl. F15D 1/00; F16K 7/00; B29C 45/40

(52) U.S. Cl. 137/15.01; 251/331; 425/542

(57) ABSTRACT

Abstract A flow means for cutting off/opening a flow of liquids or gases as well as for routing said flow, of the type that includes a body component that is manufacturable by injection molding and that is formed with a flow passage through it and has at least one sharp edge, circumferential along said flow passage. Wherein the flow means is characterized by that it includes in addition, a flow smoothening means formed as an insert that can be affixed to the flow means body component. The flow smoothening means is formed with a rounded surface that when affixing the flow smoothening means to the body component of the flow means, it integrates with the flow passage and converts the sharp edge into a rounded corner that contributes to smoothing said flow, reducing the tempest like effect of the flow and substantially preventing turbulence and generation of whirlpools.

### FIELD OF THE INVENTION

The present invention, the subject matter of this application, is the field of means for cutting off/opening the flow of liquids and gases as well as for routing such flow (for example—valves, mains, sluices, faucets, manifolds, junctions, forks, connectors, flow meters and similar items) whose body components are manufactured using processes of casting or injection molding.

### BACKGROUND OF THEN INVENTION

Professionals who are engaged it the discipline of hydrodynamics, are familiar with the characteristics of flow of liquids (and/or gases) as they pass over a smooth or rounded corner—in comparison with the mode of their flow over an acute (sharp) corner. Note that we are referring to basic (and well known) concepts of the theory of flow.

Reference is being made to FIG. 1, in which there are depicted—one by the other, two cases. FIG. 1A shows typical flow passage 10 over a rounded and smooth corner 15 of conduit 20, wherein in FIG. 1B, typical flow passage 25 is shown as it passes around an acute or in other words—sharp corner 30, (for demonstrating as it occurs in similar conduit 20).

Whereas flow 10 is “smoothed” when it traverses over corner 15, and hence it maintains its laminar flow mode, flow 25—in contradistinction, is severed from the wall of conduit 20 as it traverses the acute corner 30, in a swirl manner—forming eddies (whirlpools) in the liquid (or gas) so that it ruins the laminar flow pattern that existed in it until it reached the acute corner.

Any professional in the field knows that the quoted severing away, “tempest” like mode and forming of the whirlpools (eddies) in the flow, might lead to head losses (of pressure), that as rule reduces the hydro dynamic efficiency of the apparatus in which it occurs.

Concurrently, there are recognized and known in this field diverse means for cutting off/opening the flow of liquids and gases as well as for routing the flow as required (for example—valves, mains, sluices, faucets, manifolds, junctions, forks, connectors, flow meters and similar items) wherein in all of them, the flow required to execute at least one fly-over (passage) or more—on corners that are formed in the walls of the conduit.

Hence, and in line with all that was asserted heretofore above, professionals in this field strive to design and form the liquid passage venues means, while maintaining, as much as practicable, the highest possible level (degree) of free path between the flow entrance plane (orifice) or in other words, as it is called in the profession “the flow up stream” to the exit plane (passage) of the flow (also dubbed “the flow down stream”). Put differently, the aspiration (of the involved personnel) is to form the cutting off/opening means or the routing means wherein it will be similar as much as possible to the conduit that is “feeding” it and thus maintaining the desired optimal laminar flow mode previously existing in it.

However, in most cases, the functions that those means are required to perform on the streaming flow (namely—for example, opening, cutting off, pressure regulation and control, turning and routing, splitting and so on) renders it mandatory to implement various mechanical or electro mechanical assemblies within such flow means, that require (impose the need) that the flow would be diverted (namely, turned away)—which means that it is required to overcome the flow passage and its “fly over” (pass over) corners that are formed along the flowing path inside such flow means.

Hence, and in order to reduce as much as possible the “tempest like” or swirl behavior, the whirlpools and the disruption of the laminar flow mode—professionals in this field strive to form those problematic sectors of the flow passages inside such flow means, whose function is to divert the flow in a smooth and homogenous manner as much as practicably possible, namely while forming radii and rounded flow passages and by avoiding sharp edges.

In order to understand to what degree is the capability and expertise of the professionals in this field significant to actually implement flow passages with rounded corners to achieve this sought after performance level of the means, we refer to FIG. 2. FIG. 2 constitutes a comparative graph of testing and examining flow patterns that were conducted using a valve means endowed with sharp corners, vis a vis a similar valve but having rounded corners. The head losses are substantially higher in the valve formed with acute (sharp) corners than in that with the rounded corner. For example, at a flow rate (throughput) of 100 cubic meters per hour, the head losses in a valve formed with flow passages over sharp corners are 0.52 bar, as opposed to a much smaller head loss that was measured for a valve with rounded corners—i.e. one in which the flow passage has been “smoothed” by forming them with rounded corners and avoiding sharp corners, as explained above.

The problem is that at certain times, this clear and self evident aspiration of the professionals to form the flow passages within the flow means they are designing, with “smoothed” flow passages and as much rounded as it is practicable, is in conflict and even contradicts the advanced and modern manufacturing techniques of the main body component of such flow means, which actually is the called for one, namely the manufacturing technique they would have wanted to implement for manufacturing the principal body of the flow means.

To better elucidate the argument presented above and as an example only, we will exploit a routing flow means of the type known as “T connector”.

Reference is being made to FIGS. 3 to 7. FIG. 3 constitutes an illustration of a routing means for liquids flow of the type known as ‘T connector’ 310. Connector 310 is characterized by the fact that the function which it is said to execute is the routing of the liquid that—for example, might arrive from the flow entrance input 315 and be split unto two flow exit orifices 320 and 325.

FIG. 4 constitutes a cross section presentation of ‘T connector 310’. In FIG. 4 we can discern an additional characteristic featured in means of the type being discussed (i.e. T connector 310 in the illustrated example)—while having to overcome the passage of the flow over and its “fly over” a corner that is formed along the flow path (circumferential edge 410 in the illustrated example).

Any professional would understand that the called for one, modern and sought for manufacturing technique for producing such a means (T connector in the illustrated example) is the manufacturing of the connector by injection molding—for example, injecting a polymer material into a mold.

We refer now to FIGS. 5 to 7. FIG. 5 constitutes an illustration of T connector 310 together with part of the means that serve in its manufacturing—the three bushings 510, 515 and 520. Combining the three bushings 510, 515 and 520 one to the other inside the mold (that is not illustrated), in linear movements one with relation (reference) to others, enables to inject the raw material (for example, the polymer) around them. In the next step, after the bushings are separated one from the other (in linear motions to the opposed directions) extracting T connector 310 (that has been manufactured just now) from the mold is enabled. FIG. 6 depicts a cross section view of the bushings together with the connector means and FIG. 7 shows, also in a cross section illustration, the integration (combining) one with the other, wherein the connector means is formed around them.

Any professional would understand that due to the linear movements that are performed by bushings 510, 515 and 520, each towards the other before the injection stage, and one away from the other when they are being separated following the injection process, then verily this technique of manufacturing T connector 310 must indeed result in the circumferential edge 410 being formed as an acute (sharp) edge (as per the aspect of its formation), namely a sharp edge that in general might disrupt and reduce the hydro dynamic efficiency of the manufactured means (i.e., T connector 310 as in the illustrated example) and subsequently lead to significantly large amount (level) of the pressure head losses.

Reference is being made to FIGS. 8 and 9. FIG. 8 constitutes a cross section illustration of a T connector 810. We see clearly that T connector 810 is an “ideal” connector—one of the kind coveted by—and to which the professional—strives to reach in manufacturing. This will be a connector endowed with enhanced hydro dynamic efficiency (consequently: less head losses of pressure) because the circumferential edge 820 is formed as a rounded edge (compare it to the sharp edge 410 in T connector 310).

But, trying to use the same manufacturing means that were described here to fore when referring to T connector 310 while trying to manufacture the desired T connector 810 are destined to fail. In order to clarify the issue, attention is directed to FIG. 9—wherein the three bushings (that we have pointed at earlier) numbered 510, 515 and 520 are presented as they are integrated (combined) one in the other, and T connector 810 is “formed” on them. Sure enough, we were solely talking about a theoretical illustration, an illustration that demonstrates the impossibility (i.e., lack of capability) to manufacture T connector 810 as an integral single unit if we use the method of the integrated bushings approach that we have shown above.

Any professional would understand that the circumferential space 910 (that is illustrated and shown by blackening it—a space that is sometimes referred to in the professional lingo as “undercut”) can not be formed by restoring to use solely the technique of integrating (combining) the bushings in a linear movement one to the other, and later separating them one from the other also by a linear motions.

Note that we are solely talking about an example (T connector), and that the problem exists and is still valid when designing a variety of additional flow means including inter alia—valves, (mains-) sluices, faucets, manifolds, junctions (“forks”), connectors, flow meters and similar items, and of course, as any professional would understand—also the suggested innovative solution—that is exactly what is embodied in this patent application, as will be described below, namely it is a solution that can be implemented for overcoming the problem—and this of course refers to all the variety of above mentioned means whose optimal design calls for the same innovative technique as stipulated in this application.

Thus for example—we refer to FIGS. 15 to 17. Similarly to the insight gained by referring to FIGS. 3 to 9, that demonstrated the problem as it applied to liquid routing means of the T connector type, FIGS. 15 to 17 demonstrate the problem as it applies (refers) to a cutting off/opening means for liquids flow—a valve means in this particular example.

FIG. 15 is an illustration in perspective of the body component 1510 of a valve. FIG. 16 constitutes an illustration depicting the same component 1510, as viewed from a different angle. FIG. 17 presents a cross section view of the component 1510 body component 1510 is another example of a non satisfactory manufactured body component, wherein any professional would understand that the capability to manufacture body component 1510 by injection molding over an array of linearly moveable bushings (not illustrated), as it is materialized in the illustrated example of body component 1510, is limited by being reconciled to the creation (through forming) of sharp corners 1710 and 1712 as shown at the circumference of flow passage 1720 (the sharp corners in the figure were stressed, in order to alleviate comprehension).

Hence, observe that in view of the examples presented above, when referring to (the) flow means of the T connector type (FIGS. 3 to 9) as well as when referring to means of the valve types (FIGS. 15 to 17), any professional in the field of designing and developing of flow means for cutting off/opening or means for routing the flow of liquids and gases in—for example—valves, sluices, faucets, manifolds, junctions, forks, connectors, flow meters and similar (body), would appreciate the fact that—prior to the availability of the invention that would be presented below, the professional clear and an easily understood aspiration to form the flow passages (those that he was engaged in designing them), with “smoothed” flow passages and as much as practicable rounded corners, in order to achieve high hydro dynamic efficiency and reduction of the pressure head losses. This ambition might have run head on (“collided”) and be in contradiction to the manufacturing technique of injecting molding wherein an array of bushings assembled by a linear movement—one to the other, for forming the internal flow passages. In other words—

Prior to this present invention, a professional in the field of designing and developing flow means for cutting off/opening or for routing the flow of liquids and gases—for example valves, sluices, faucets, manifolds, junctions, forks, connectors, flow meters and similar means, did not have a solution to the problem of how to achieve the undercut configuration that he needs, for the sake of obtaining a smooth and rounded corner of the flow passages in the body component of the specific flow means, while being able to intensively use the injection molding manufacturing technique.

### SUMMARY OF THE INVENTION

The present invention—the subject matter of this application, is apt to be implemented in a large variety of flow means used for cutting off/opening and/or for routing the flow of liquids and gases, for example valves, sluices, faucets, manifolds, junctions, forks, connectors, flow meters and similar means that are characterized by the fact that they include a body component that is amenable to be manufactured by injection molding (of suitable material) and that is formed with a liquids (or gases) flow through it and that it has at least one acute (sharp) edge, circumferentially positioned around the flow passage.

The invention—the subject matter of this application, is characterized by the fact that it maintains the capability to continue manufacturing the desired body components of any of the means (listed above and similar ones) using the well known techniques of injection molding while separating the flow “smoothing” function and allocating it to an additional, separate means.

In accordance with the invention—the subject matter of this application, such flow means (for example—valves, sluices, faucets, manifolds, junctions, forks, connectors, flow meters and other similar means) will include in addition, a flow smoothening means that will be formed as an insert that can be embedded into the flow means body.

The flow smoothening means would be formed with a rounded surface that upon embedding, as said, the flow smoothening means into the flow means body component, the rounded surface would be integrated with the flow means flow passage and transform the sharp edge into a rounded one that contributes to smoothing the flow, reduces the tempest like or swirl effect of the flow and substantially prevents turbulence and generation of whirlpools.

In another and additional aspect of the present invention, both the flow means body component and the insert which constitutes the flow smoothening means (which is the characterized feature of the invention), are manufactured by injection molding.

In another aspect of the present invention, there is embodied in it a general method for reducing the (pressure) head losses in said cutting off/opening means for liquid and gases as well as in routing means for liquids or gases, by smoothing the flow and in consequence reducing the tempest like or swirl effect of the flow and substantially preventing turbulence (whirlpools), by a separate and dedicated means.

The method includes the steps of:

forming by injecting molding a body component of a flow means, while receiving unwillingly, at least one sharp edge that is formed around the flow passage in the body component.

In the second stage, the method may further comprise affixing of the separate and dedicated means, namely the flow smoothening means, that is formed with a rounded surface unto the body component is executed wherein the flow smoothening means is integrated with the flow passage and converts the sharp edge into a rounded corner, thus contributing to reducing the tempest like or swirl effect as much as possible and substantially preventing the build up of whirlpools.

### BRIEF DESCRIPTION OF THE ACCOMPANYING FIGURES

The present invention will be described herein in conjunction with the accompanying figures. Identical components, wherein some of them are presented in the same figure—or in case that a same component appears in several figures, will carry an identical number.

FIG. 1 to FIG. 9 constitute, as said, illustrations of various prior knowledge items to which we referred earlier in the “background of the invention” chapter.

FIG. 1 (that includes FIG. 1A and FIG. 1B) illustrates a flow passage with a rounded edge and another one with a sharp edge, respectively.

FIG. 2 constitutes a presentation of a test graph obtained by conducting a comparative flow experiment on two valves: one with sharp corners and the other with rounded corners.

FIG. 3 constitutes an illustration of a liquids flow routing means of the type known as ‘T Connector’.

FIG. 4 constitutes a cross section view of the ‘T Connector’ illustrated in FIG. 3.

FIG. 5 constitutes an illustration of the ‘T Connector’ illustrated in FIG. 3, shown together with the three bushings that serve for its manufacturing by injection molding.

FIG. 6 shows a cross section view of the ‘T Connector’ together with the bushings as depicted in FIG. 5.

FIG. 7 constitutes a cross section view depicting the integration of the bushings that were illustrated in FIG. 6, wherein the ‘T Connector’ that is also illustrated there is formed around them.

FIG. 8 constitutes a cross section view depicting a ‘T Connector’ endowed with a round corner (i.e., obtaining enhanced hydro dynamic efficiency).

FIG. 9 constitutes a cross section view depicting the integration of the bushings illustrated in FIG. 7, wherein the ‘T Connector’ with the round corner illustrated in FIG. 8, is illustrated as if it is “formed” on them (intended to provide a visual expression to the inability to actually achieve ‘T Connector’ endowed with a round corners).

FIG. 10 constitutes a cross section view of a ‘T Connector’ that includes a body component and a flow smoothening means in accordance with the invention.

FIG. 11 constitutes an illustration in cross section of a ‘T Connector’ fulfilled in accordance with the invention that has been illustrated in FIG. 10, wherein its body component is illustrated separately from the flow smoothening means.

FIG. 12 (that includes two figures, namely 12A and 12B) constitutes illustrations of parts of the injection mold for the flow smoothening means as was illustrated in FIG. 11 (view in perspective in FIG. 12A and by a cross section view in FIG. 12B).

FIG. 13 constitutes an illustration of parts of the injection mold for the body component as was illustrated in FIG. 11.

FIG. 14 constitutes a cross section view of parts of the injection mold for the body component as was illustrated in FIG. 13

FIGS. 15 to 17 are as said, and similar to FIGS. 1 to 9, illustrations depicting ‘prior art’ and to them we have already referred above, in the “Background of the Invention” chapter, wherein—

FIG. 15 constitutes an illustration in perspective of the body component of a valve that can be manufactured by injection molding but while getting a (non desired) sharp (acute) edge in its flow passage.

FIG. 16 constitutes a view in perspective illustrating the body component of a valve, as was illustrated in FIG. 15, viewed from a different angle.

FIG. 17 constitutes a cross section view illustrating the body component of a valve—that was also illustrated in FIGS. 15 and 16.

FIG. 18 constitutes an illustration of a body component of a valve, manufacturable by injection molding and that is adapted to accept (e.g. by embedding) flow smoothening means in it as per the present invention.

FIG. 19 constitutes a cross section view of the body component illustrated in FIG. 18.

FIG. 20 constitutes an illustration of the body component that was illustrated in FIG. 18 and FIG. 19 alongside the flow smoothening means.

FIG. 21 constitutes an illustration from another angle of the body component and the flow smoothening means that were illustrated in FIG. 20.

FIG. 22 constitutes an illustration of the flow smoothening means and of the body component that were illustrated one alongside the other in FIGS. 20 and 21.

FIG. 23 constitutes a cross section illustration of the flow smoothening means wherein it is embedded into the body component as it was illustrated FIG. 22.

FIG. 24 constitutes an exploded view (parts breakdown illustration) of a diaphragm valve type of flow means that includes a body component and two flow smoothening means in accordance with the present invention.

FIG. 25 constitutes an assembly view of a diaphragm valve means in accordance with the invention whose components were illustrated in FIG. 24.

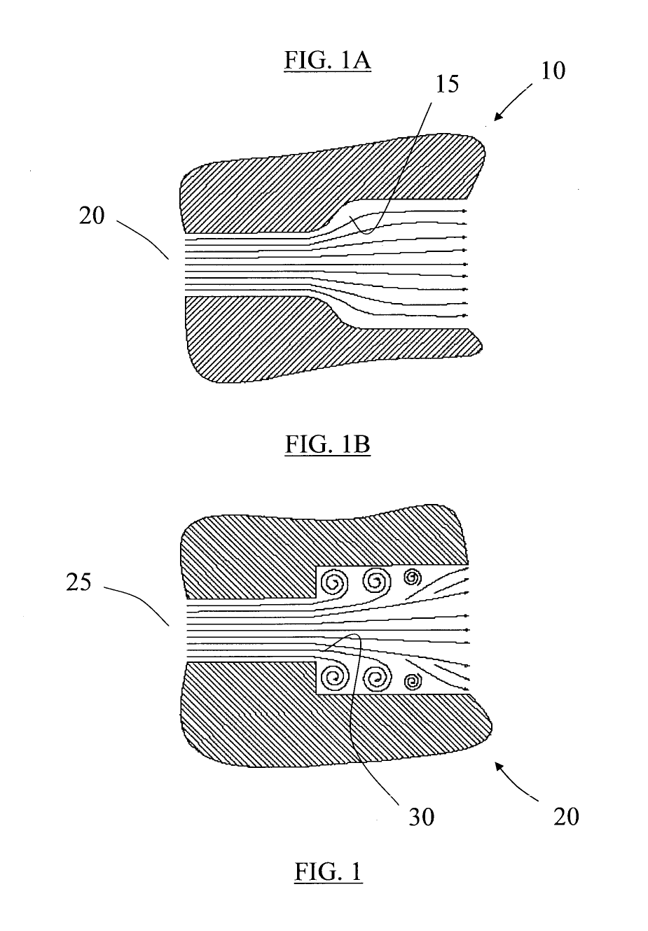

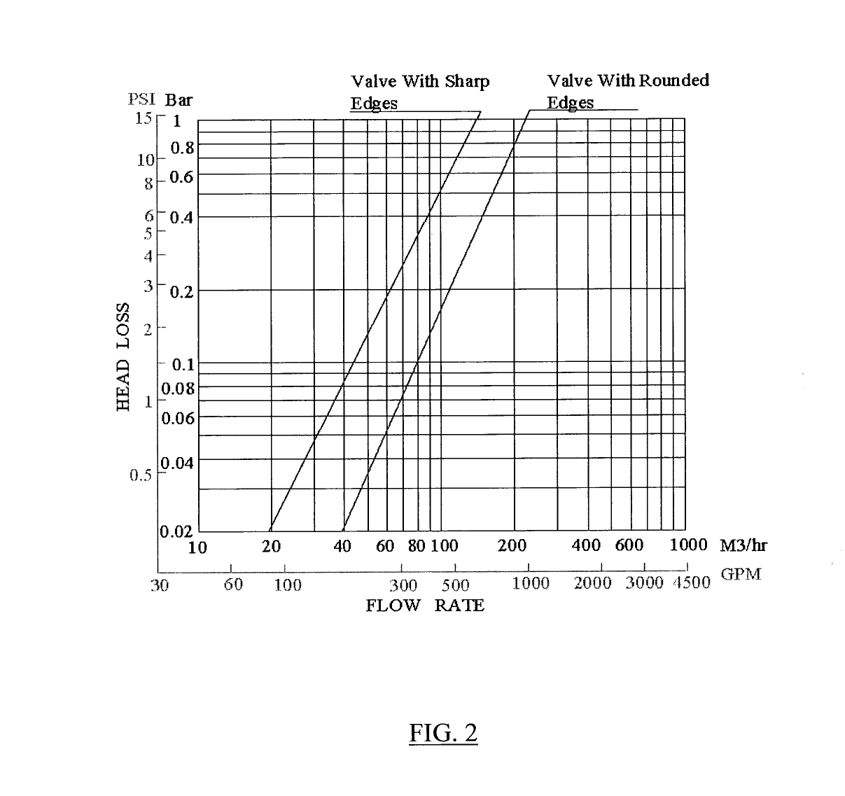

### DETAILED DESCRIPTION OF A PREFERRED EMBODIMENT OF THE PRESENT INVENTION

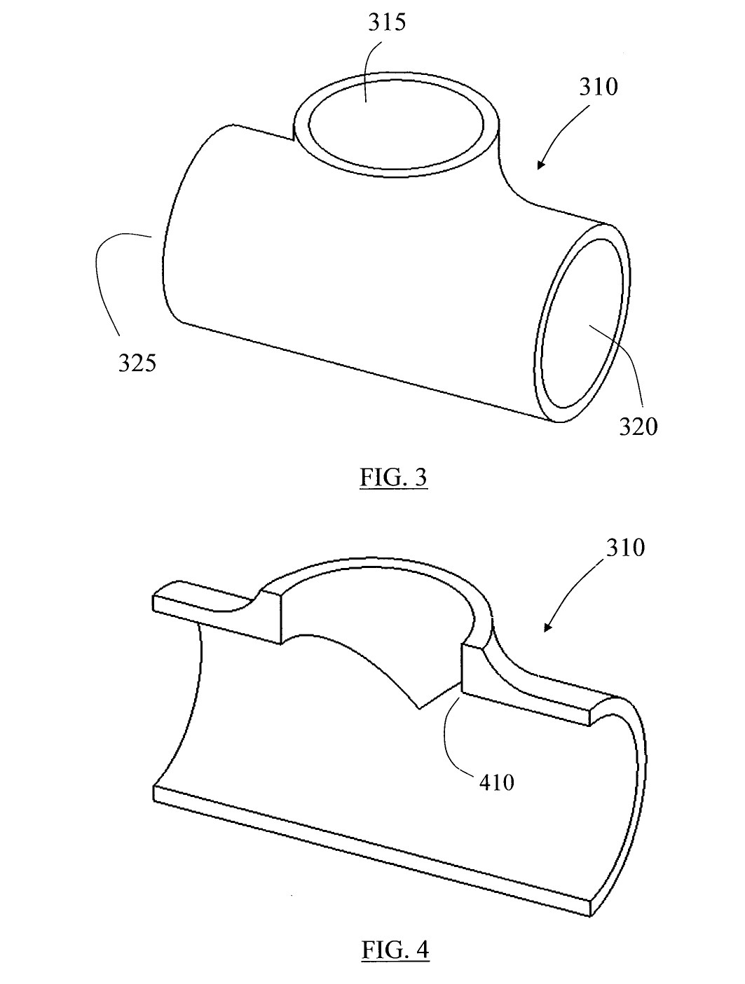

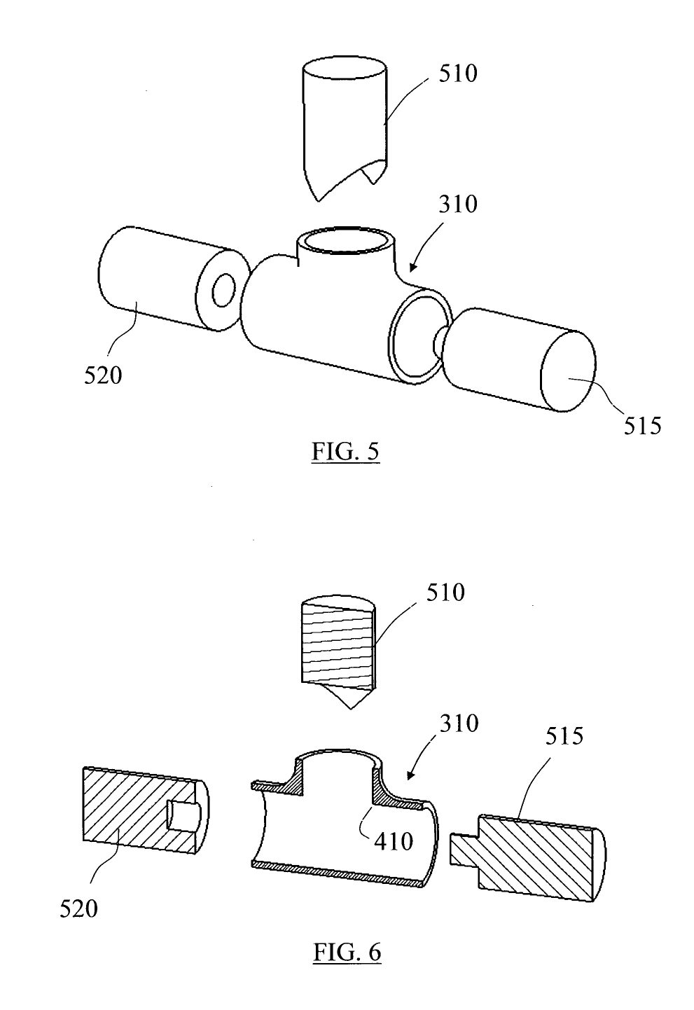

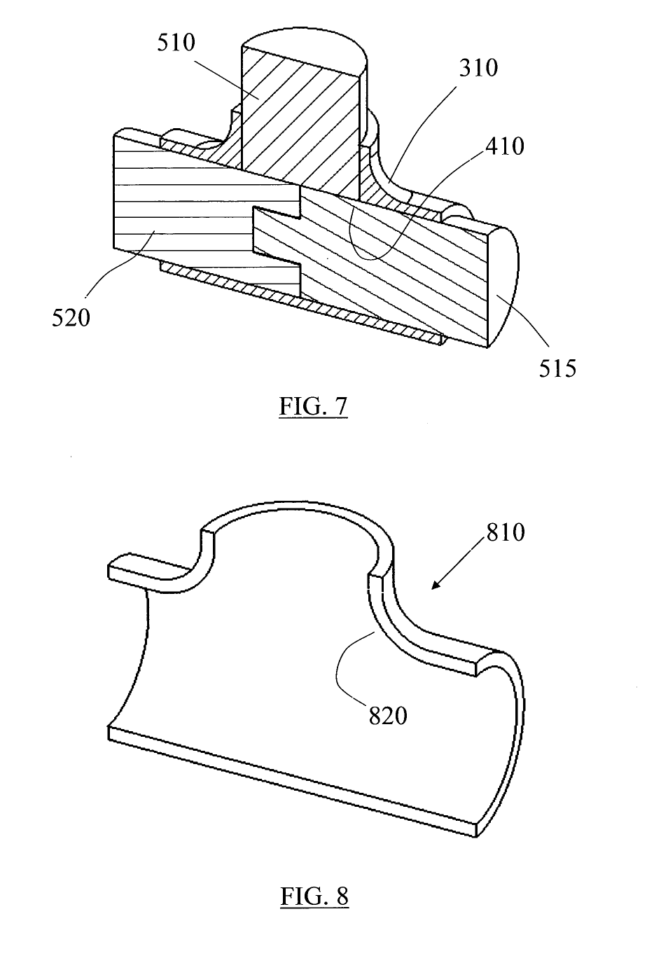

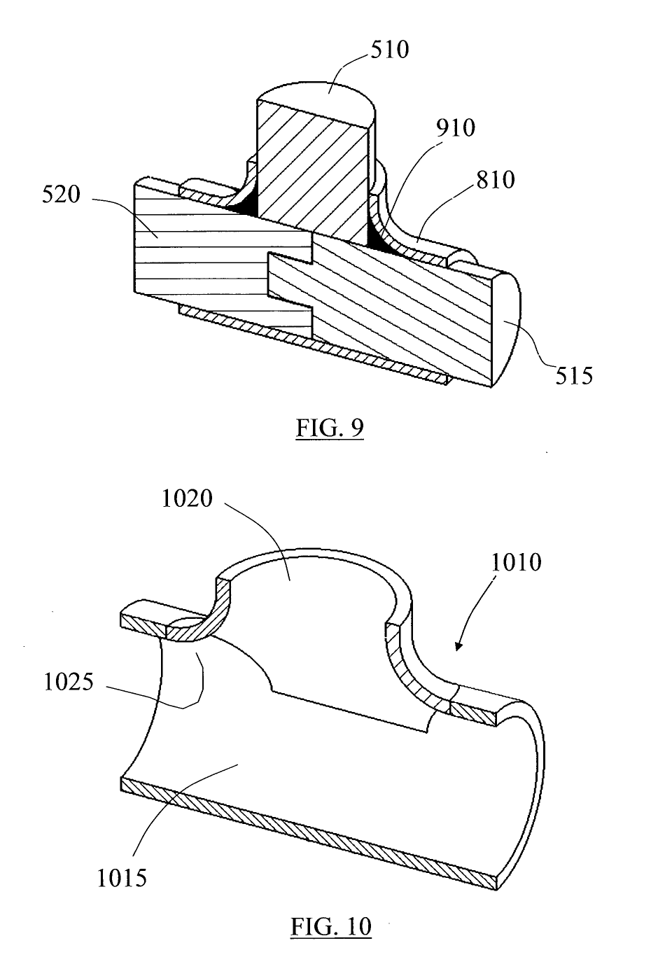

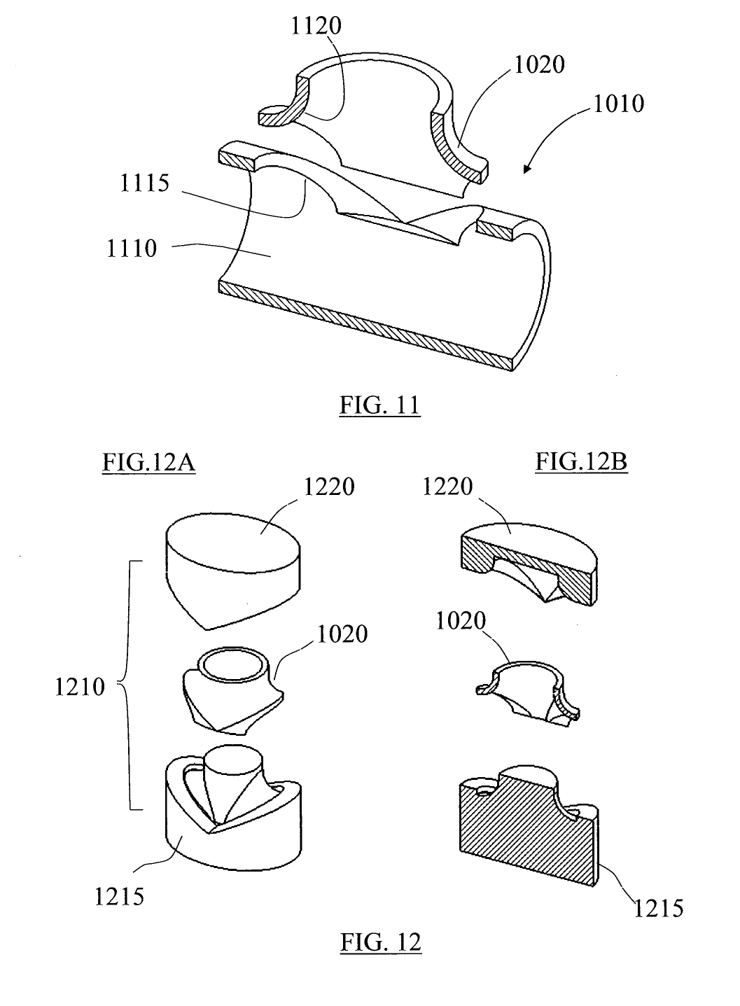

Reference is made to FIGS. 10 and 11. These figures show the implementation of the invention as applied to flow means of the ‘T Connector’ type (a flow means commonly used for routing the flow of a liquid or gas). Note the embodiment of the invention as it will be described below and compare it to the prior art (as it was described above when referring g to FIGS. 3 to 9).

FIG. 10 constitutes a cross section view of a ‘T Connector’ 1010 that includes a body component 1015 and a flow smoothening means 1020 in accordance with the invention. FIG. 11 constitutes an illustration in cross section of a ‘T Connector’ 1010 wherein its body component 1015 is illustrated separately from the flow smoothening means 1020.

In accordance with the characteristics feature of the invention that we have pointed above, the capability to continue manufacturing the body component 1015 using the injection molding techniques is maintained in this case while separating the flow “smoothening” function and assigning it to an additional, separate dedicated means—the flow smoothening means 1020.

The flow smoothening means 1020 will be fanned as an insert that is amenable to be affixed to body component 1015 (for example—by bonding/gluing, heat soldering, ultra sonic welding, soldering by induction and so on).

Body component 1015 is formed with a flow passage 1110 through it and a circumferential acute (sharp) corner 1115 around the flow passage.

The flow smoothening means 1020 is formed with a rounded surface 1120 that upon embedding the flow smoothening means 1020 into body component 1015 as said, it is integrated with the flow passage 1110 and converts the sharp corner 1115 into a rounded corner 1025 that contributes to smoothing the flow, reducing the tempest like effect of the flow and substantially prevents turbulence and the generation of whirlpools.

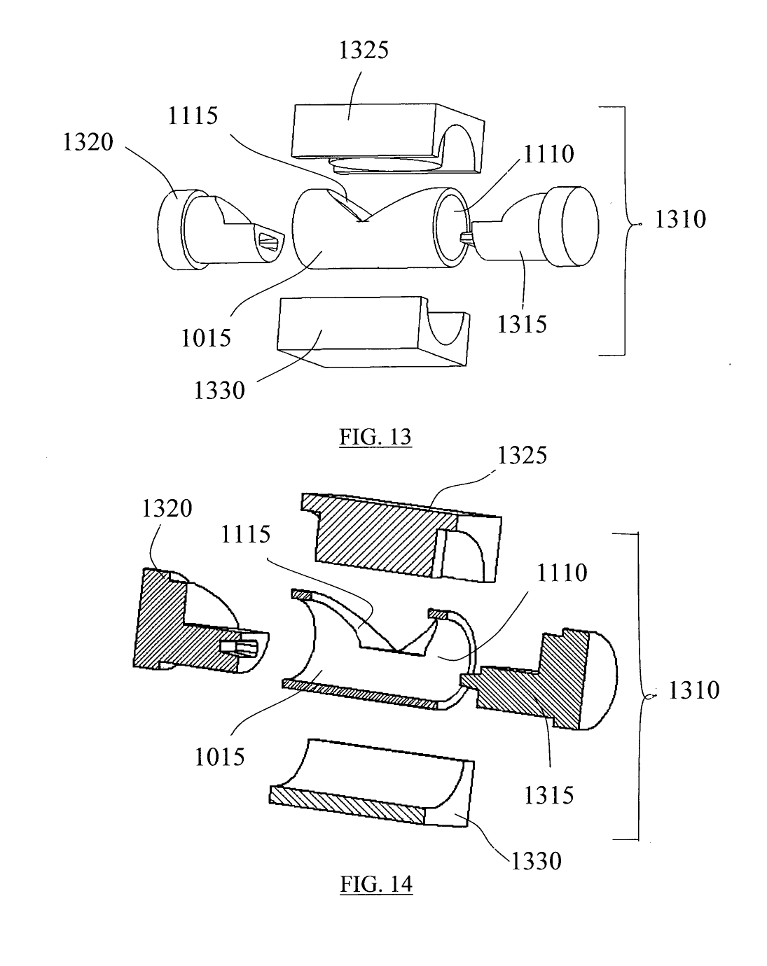

Reference is being made to FIGS. 12 to 14. FIG. 12 (that includes two drawings, FIGS. 12A and 12B, respectively), constitutes an illustration of the injection mold 1210 used to produce the flow smoothening means 1020 (FIG. 12A shows a perspective aspect, FIG. 12B—respectively, a cross section). Mold 1210 includes a “male” bushing 1215 and a “female” bushing 1220. FIG. 13 constitutes an illustration of the parts of the injection mold 1310 for manufacturing body component 1015. FIG. 14 constitutes a cross section view of parts of the injection mold 1310 for the molding of body component 1015. Mold 1310 includes the bushings 1315 and 1320 that can be coupled one to the other in a linear movement for forming flow passage 1110, and the two parts 1325 1330 of the mold that fowl the external shape of the body component 1015 and sharp corner 1115.

Thus, Any professional would appreciate the fact that as per ‘T Connector’ 1010, both body component 1015 and the flow smoothening means 1020 that characterizes the invention, are—each by itself, manufacturable by injecting injection molding.

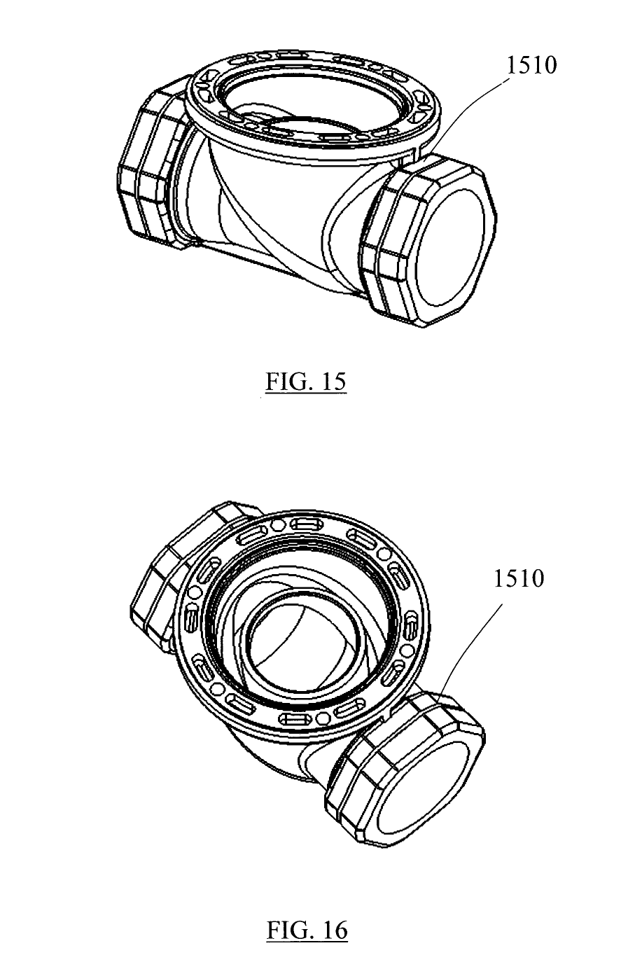

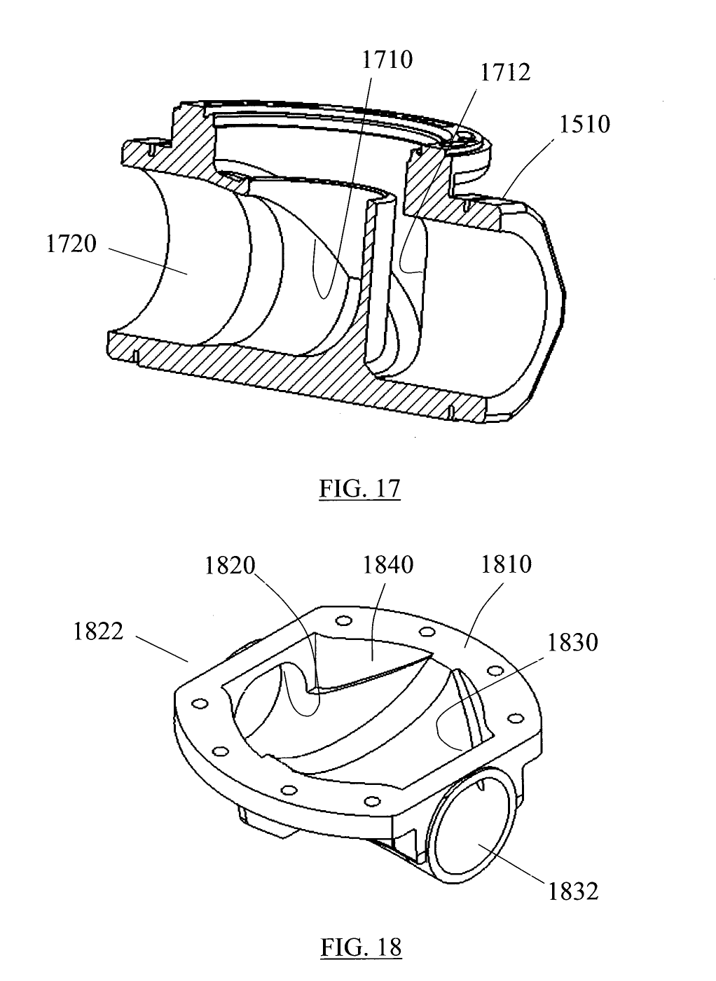

Reference is now being made to FIGS. 18. to 23. The figures describe the implementation of a diaphragm type of valve (observe the implementation of the invention as it will be disclosed below, and compare it to the prior art that was described above when referring to FIGS. 15 to 17).

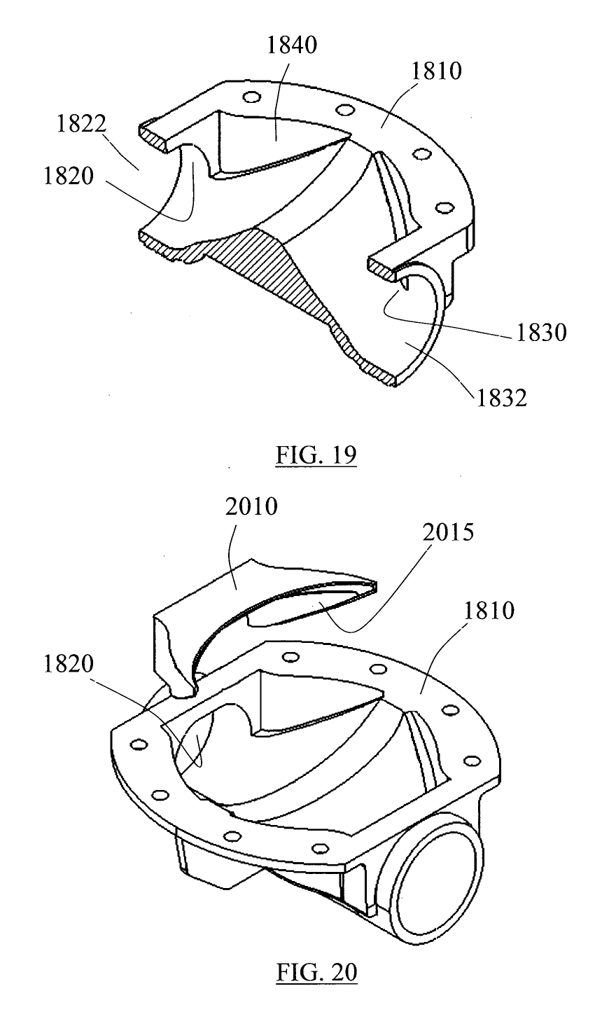

FIG. 18 constitutes an illustration of body component 1810 of a valve that is manufacturable by injection molding of a plastic material and as explained below, suitable to accept—embedded in it, flow smoothening means in accordance with the invention. FIG. 19 constitutes a cross section view of body component 1810. As can be discerned, due to it being manufactured by injection molding via an array of entwined bushings (not illustrated), body component 1810 is formed with sharp corners 1820 and 1830 that, respectively, are left in the flow passage from the flow input entrance 1822 to the inside of space 1840 of the body component and through the flow passage from inside of space 1840 to the flow exit orifice 1832 (for clarifying the issue the sharp edges were marked and stressed).

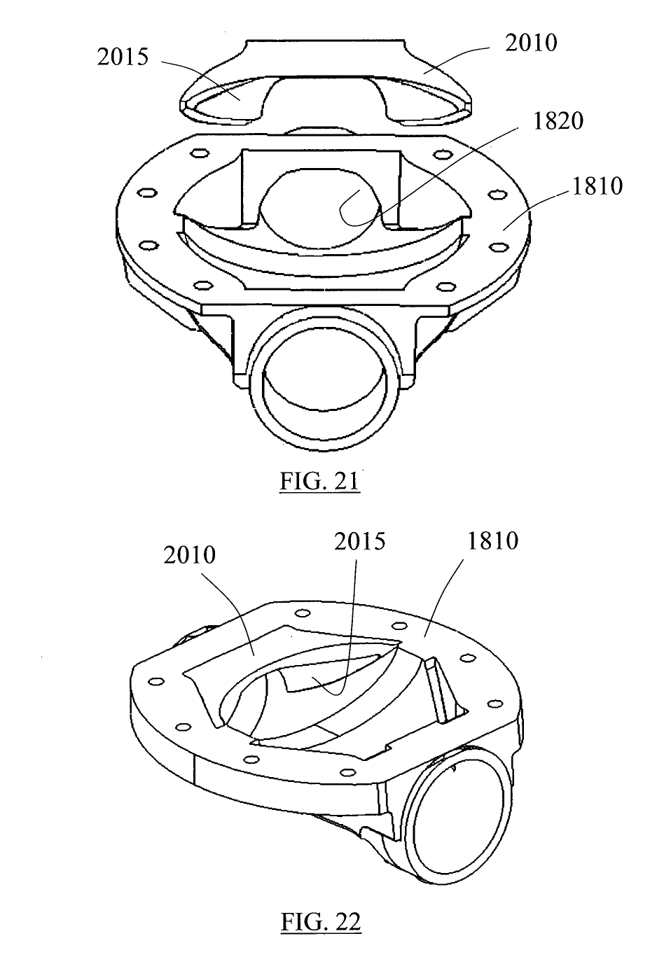

Reference is made to FIGS. 20 and 21. In accordance with the characteristic feature of the invention (that as we have pointed at earlier), in regards to the diaphragm valve means, whose body component 1810 is illustrated, it is to be noted that that the capability to continue manufacturing the body component 1810 using the injection molding technique, is indeed maintained while separating the flow “smoothing” function and assigning it to an additional separate means—a flow smoothening means 2010 that is formed with a rounded surface 2015.

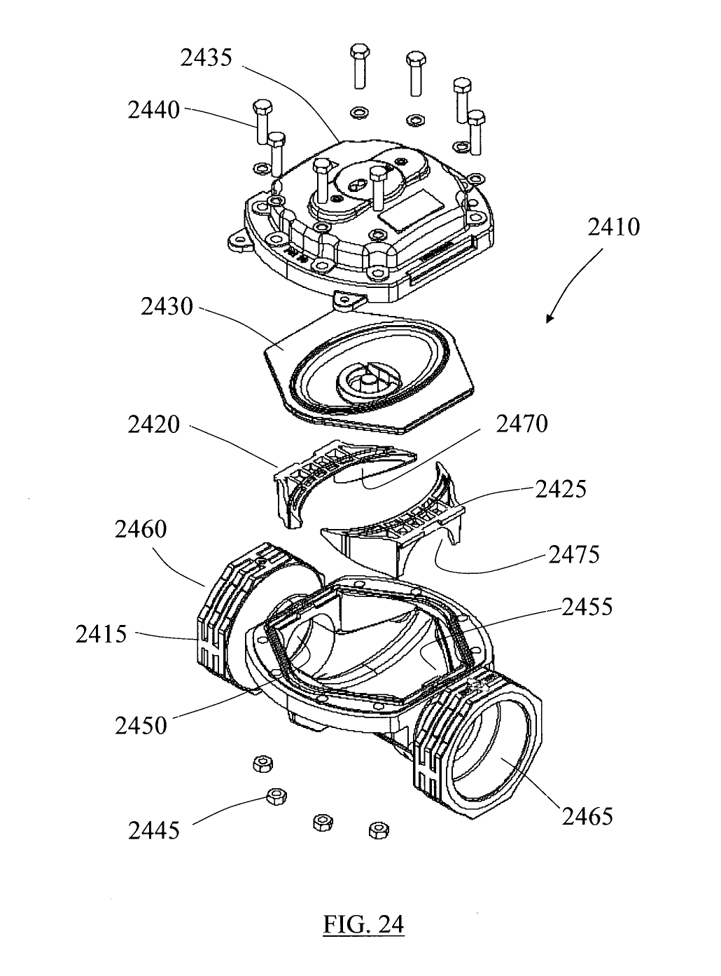

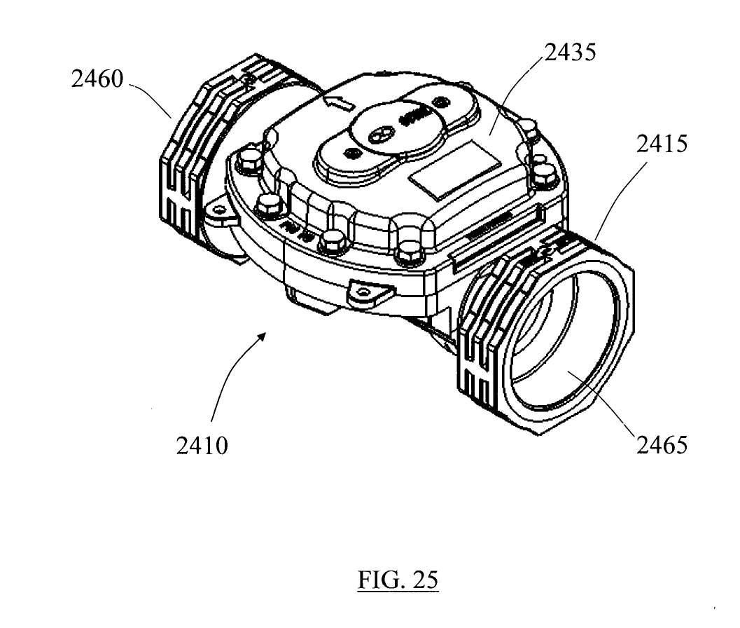

Note that any professional in this field would understand that in body component 1810—that as said, is formed with two sharp edges, namely 1820 and 1830, there will be installed two flow smoothening means units, and see further below more details regarding this point (while referring to FIGS. 24 and 25).

FIG. 21 constitutes an illustration from another angle of body component 1810 and flow smoothening means 2010.

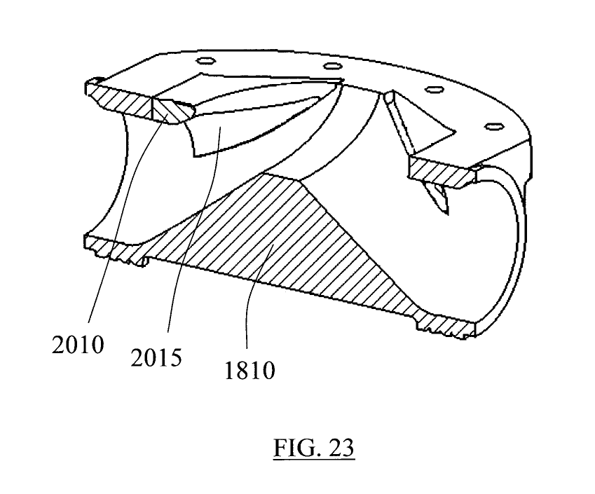

We refer to FIG. 22. This figure constitutes an illustration of flow smoothening means 2010 and body component 1810 wherein they are shown affixed one to the other. Smoothing means 2010 is formed as an insert linkable to body component 1810 (for example—through exploiting the cover component of the valve (that is not illustrated) for tightening flow smoothening means 2010 to body component 1810, bonding (gluing), heat soldering, ultra sonic welding, soldering by induction, an ensemble of dismountable connecting means such as bolts or pins and so on).

We refer to FIG. 23. This figure constitutes a cross section illustration of flow smoothening means 2010 as it is embedded in body component 1810. Any professional would appreciate the fact that upon embedding as said of flow smoothening means 2010 to body component 1810, the rounded surface 2015 is integrated into the flow passage and converts the sharp edge 1820 into a rounded edge that contributes to the smoothing the flow, reducing the tempest like effect of the flow and substantially preventing turbulence and generation of whirlpools.

We refer to FIGS. 24 and 25. FIG. 24 constitutes an “exploded” view (parts breakdown illustration) of a diaphragm valve type of flow means 2410 that includes a body component 2415 and two flow smoothening means in accordance with the invention, namely 2420 and 2425. FIG. 25 constitutes an assembly view of a diaphragm valve means 2410.

In addition to body component 2415 and the two flow smoothening means 2420 and 2425, diaphragm valve means 2410 includes also an elastic diaphragm element 2430, a cover member 2435 and an array of connecting means, in the illustrated example—an array of bolts 2440 and nuts 2445, that serve to fasten cover means 2435 to body 2415 while holding diaphragm 2430 there between and affixing the flow smoothening means 2420 and 2425 to body component 2415.

Any professional would understand that both body component 2415 and flow smoothening means 2420 and 2425 are—each one by itself, manufacturable by injection molding (see also the outline of the voids presented in the illustrated example, formed on their outer surfaces in order to use less raw material for the injection process thus gaining reduced weight without sacrificing their inherent strength).

For lack of any other option and as was explained above, the body component 2415 that is formed by injecting molding through an array of bushings (that are not illustrated) which capable of linear motion, even though (as said), the outcome is a body component with two sharp edges 2450 and 2455 (the latter is not seen)—one at the flow input entrance 2460 into the body of the valve and the other, at the flow exit orifice from it—2465, respectively.

The two units of the flow smoothening means 2420 and 2425 are formed as an inserts that can be affixed to body component 2415 and are formed, each of them, with a rounded surface 2470 and 2475, respectively.

Any professional would understand that upon affixing the two flow smoothening means units to the body component, the two rounded surfaces 2470 and 2475 become integrated with—(are coupled to—) the flow passage and convert the sharp edges (2450 and 2455, respectively) to rounded corners that, as said, contribute to smoothing the flow, reducing the tempest like effect of the flow and substantially preventing turbulence and generation of whirlpools.

Furthermore, in view of what was described above while referring to the accompanying figures, any professional would understand that in the invention presented above, it is also described and assimilated an aspect of a general method for reducing pressure head losses in cutting off/opening means for liquid and gases as well as in or routing means for liquid and gases, and this through smoothing the flow over rounded surfaces of the edges and reducing the phenomena's of the tempest like effect of the flow, substantially preventing turbulence and generation of whirlpools, through resorting to adding a separate and dedicated means (the flow smoothening means that is the subject matter of this invention).

The method includes the steps of:

forming by injection molding a body component of a flow means, while receiving unwillingly, at least one sharp edge that is formed around the flow passage in the body component.

See for example, in the illustrated examples presented by FIGS. 10 to 14, body component 1015 that is formed by injecting molding of plastic material, with flow passage 1110 through it and sharp edge 1115 circumferential around the flow passage. In the illustrated example of FIGS. 18 to 23, body component 1810 that is formed by injection molding of plastic material, with sharp edges 1820 and 1830, that are left in the flow passage from the flow input entrance 1822 into the inside of space 1840 of the body component and through the flow passage from inside of space 1840 to the flow exit orifice 1832 respectively, and the example illustrated by FIGS. 24 and 25—body component 2415 that is formed by injecting molding of plastic material, with two sharp edges 2450 and 2455, one in the flow entrance 2460 to the body of the valve and the other at the flow exit orifice 2465 and out of it, respectively.

In the second step, the method calls for affixing of the separate and dedicated means, namely—the flow smoothening means, that is formed with a rounded surface unto the body component is executed wherein the flow smoothening means is integrated with the flow passage and converts the sharp edge into a rounded corner, thus contributing to reducing the tempest effect like or swirl as much as possible and substantially preventing the build up of whirlpools.

See for example—flow smoothening means 1020 in the example illustrated by FIGS. 10 to 14. Observe also—flow smoothening means 2010 in the example illustrated by FIGS. 18 to 23, and flow smoothening means 2420 and means 2425 in the example illustrated by FIGS. 24 and 25.

Any professional in this field would understand that the flow smoothening means for flow passages and the general method for reducing pressure head losses in means for said cutting off/opening and/or routing flow of liquids and gases, were described above solely in a way of presenting examples, and there is nothing in this to revoke equivalent alterations nor implement variants in design, that would not render the device to deviate from the method embodied in the invention which is the subject matter of this application, and which is defined in the claims that follow. In other words, it is feasible to implement the invention as it was described above while referring to the accompanying figures, also with introducing changes and additions that would not depart from the constructional and operational steps, characteristics of the invention, characteristics that are claimed herein under in the claims.

1. A flow means for cutting off/opening a flow of liquids or gases as well as for routing said flow, comprising:
a body component that is manufacturable by injection molding, and formed with a flow passage having at least one sharp edge, circumferential along said the flow passage; and
a flow smoothening means formed as an insert that may be affixed to the body component;
wherein the flow smoothening means is formed with a rounded surface and when the flow smoothening means is affixed to the body component, the flow smoothening means converts the sharp edge of the flow passage into a rounded corner that contributes to smoothing the flow of liquids or gases, thereby reducing tempest-like effects within the flow of liquids or gases and substantially preventing turbulence and/or generation of whirlpools.

2. The flow means of claim 1, wherein said flow means is a T connector.

3. The flow means of claim 1, wherein
said flow means is a diaphragm-type valve comprising a body component with two sharp edges, the first sharp edge at a flow input entrance into the valve body and a second sharp edge at a flow exit orifice of the body component; and
two flow smoothening means capable of affixation to the body component.

4. The diaphragm-type valve of claim 3, further comprising
an elastomeric made diaphragm component;
a cover component; and
an array of connecting means, serving to fasten the cover component to the body component while holding the diaphragm component and affixing the flow smoothening means unto the body component.

5. The flow means of claim 1, wherein the flow smoothening means may also be manufactured by injection molding.

6. A method for reducing pressure head losses in a flow means for cutting off/opening a flow of liquids or gases as well as for routing the flow, by smoothing the flow, thereby reducing effects of tempest-like phenomena with the flow and substantially preventing turbulence and probable generation of a whirlpool, by introducing a separate and dedicated means, wherein the method comprises the steps of:
forming by injection molding a body component of the flow means, while creating unavoidably, at least one sharp edge that is formed around a flow passage in a body component; and
affixing a separate and dedicated means, namely—a flow smoothening means, that is formed with a rounded surface onto the body component, wherein the flow smoothening means is integrated with the flow passage and converts the sharp edge into a rounded corner, thereby reducing a tempest like or swirl phenomena and substantially preventing a buildup of whirlpools.

7-8. (canceled)

9. The flow means of claim 1, wherein the flow smoothening means is affixed to the body component by bonding, gluing, welding, soldering, or a mechanical connection selected from the group consisting of: bolts and nuts, screws, pins, clamps and combinations thereof.

10. The flow means of claim 1, wherein the flow means is a valve, main, sluice, faucet, manifold, junction, fork, connector, or flow meter.

11. An injection mold for use in the manufacture of a flow means within a flow passage to reduce tempest-like effects of a flow of liquids or gases through the flow passage, comprising a smoothening mold and a body component mold, wherein the molds are configured to produce a flow smoothening means and capable of affixation to a body component, wherein the body component has a flow passage and at least one sharp edge, circumferential along the flow passage; wherein the flow smoothening means converts the sharp edge of the flow passage into a rounded corner thereby reducing tempest-like effects of the flow of liquids or gases through the flow passage.

12. The injection mold of claim 11, wherein the smoothening mold comprises a rounded corner section, a first end section, and a second end section.

13. The injection mold of claim 12, wherein the first end section is a male bushing and the second end section is a female bushing.

14. The injection mold of claim 11, wherein the body component mold comprises a first end section, a second end section, a first external shaping section, and a second external shaping section.

15. The injection mold of claim 14, wherein the first end section is a male bushing and the second end section is a female bushing.

16. The injection mold of claim 14, wherein the first external shaping section forms a solid exterior of the body component and the second external shaping section forms the opening of the body component.

17. The injection mold of claim 16, wherein the flow smoothening means is designed to be affixed to the opening of the body component, thereby forming the rounded corners within the flow passage.
